(19) United States
(12) Patent Application Publication
(10) Pub. No.: US 2013/0069445 A1
(43) Pub. Date: Mar. 21, 2013

(54) RECEIVER COIL

(71) Applicant: Eberhard Waffenschmidt, Aachen (DE)

(72) Inventor: Eberhard Waffenschmidt, Aachen (DE)

(73) Assignee: KONINKLIJKE PHILIPS ELECTRONICS N.V., EINDHOVEN (NL)

(21) Appl. No.: 13/700,181

(22) PCT Filed: May 10, 2011
(86) PCT No.: PCT/IB11/52042

§ 371 Date: Nov. 27, 2012

(30) Foreign Application Priority Data
May 28, 2010 (EP) 10164209.8

(51) Int. Cl. H01F 38/14

(52) U.S. Cl. CPC H01F 38/14
USPC 307/104

(57) ABSTRACT

The invention relates to a planar receiver coil for use in a receiving device for receiving power from a transmitting device inductively, the receiver coil is intended to be coupled with a transmitter coil of said transmitting device, said receiver coil constituted by winding turns, wherein the winding turns at the outer part of the receiver coil are denser than the winding turns at the inner part of the receiver coil.

### FIELD OF THE INVENTION

The invention relates to an inductive power transmission system, more particularly, to an improved receiver coil in such a system.

### BACKGROUND OF THE INVENTION

Generally, inductive power transmission systems are frequently used in many applications. They allow powering of devices or charging of batteries (or capacitors) without wired connection. This is especially advantageous in environments where no electrical plugs and connectors are allowed, such as bathrooms and special rooms in hospitals, or where electrical plugs and connectors are not practical.

An inductive power transmission system is realized with the help of inductive coupling. Its power can be drawn from e.g. a public grid or from a battery. It is preferably realized as a resonant half-bridge or full-bridge converter with soft-switching behavior. A transmitting device comprises at least one transmitter coil (hereinafter also referred to as transmitter coil). A mobile device comprises a receiving coil (hereinafter also referred to as receiver coil) coupled with said transmitter coil, e.g the mobile device is put on the surface of the transmitting device. The current provided to the primary coil of the transmitting device generates an alternating magnetic field. This alternating magnetic field induces a voltage in the secondary coil of the mobile device. The voltage is rectified and then fed to the load or batteray of the mobile device.

In existing simple systems a lateral displacement of the receiver coil to the transmitter coil leads to a change of the coupling factor and thus an unwanted variation of the power transfer. Therefore, in such systems, the receiver coil cannot be positioned freely; it should be put at a predefined position.

A solution to avoid such unwanted variation of the power transfer at the different position of the transmitter coil, i.e. to support a function of positioning the receiver coil freely, is to design the transmitter coil such that it can generate a homogeneous electromagnetic field in terms of position.

As an example, a “hybrid” structure of a transmitter coil with linear distribution added with additional turns at the outer edge is proposed. It is based on the insight that a transmitter coil with a turn distribution with equal distances of the turns (“linear distribution”) has a peak of coupling at the centre of the transmitter coil, while a transmitter coil with turns only at the outer edge has the maximum coupling, if the outer edges of transmitter and receiver coil match. This solution gives a better lateral homogeneity of the coupling than a coil with equal turn distribution, but still has distinct minima and maxima.

A somewhat more decent approach to design the distribution of the turns of the transmitter coil is introduced. It is a distribution function for the radial position r of the winding turns with index i:

r(i)=[(i-1)/N] (1)

where N=number of turns. The parameter k is an empirical value. For k=1, the turns are linearly distributed. For k<1 the turns are denser to the outer side of the coil. Nevertheless, the approach results in a structure, which has the characteristics necessary to generate a homogeneous magnetic field, which is needed to achieve a less severe dependence with the position on a lateral displacement, i.e. achieve free poisoning function.

### OBJECT AND SUMMARY OF THE INVENTION

Although, with the special designed transmitter coil, it can generate a fairly even electromagnetic field and achieve free poisoning function, it just partly solves the free poisoning problem. In some other scenario, for example, if the transmitting device does not contain above mentioned special arrangement regarding winding turns distribution of the transmitter coil, the transmitting device cannot generate an even electromagnetic field anymore, and as a result, a receiving device cannot be put on any position of the transmitter coil.

Therefore, it is an object of the invention to find a solution for free positioning the mobile device no matter whether the generated electromagnetic field is homogeneous or non-homogeneous.

To this end, a planar receiver coil is proposed for use in a receiving device for receiving power from a transmitting device inductively. The receiver coil is intended to be coupled with a transmitter coil of said transmitting device, said receiver coil constituted by winding turns, wherein the winding turns at the outer part of the receiver coil are denser than the winding turns at the inner part of the receiver coil.

With such an improved receiving coil, a receiving device comprising the improved receiving coil can receive power homogeneously no matter whether the generated electromagnetic field is homogeneous or non-homogeneous. As a result, as long as the receiving coil is larger than the transmitter coil and cover the transmitter coil, the receiving coil can be positioned on the transmitter coil freely.

The invention also proposes a receiving device comprises the proposed planar receiver coil for receiving power from a transmitting device inductively.

According to an embodiment of the invention, an algorithm to determine the winding turns distribution of the receiver coil is proposed.

By using the proposed receiving device, the receiving device can receive almost the same amount of flux i.e. can receive homogeneous power on any position on the transmitter coil no matter the electromagnetic field generated by the power transmitting device is homogeneous (even) or non-homogeneous (uneven) as long as the transmitter coil is smaller than the receiver coil and covered by the receiver coil.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIGS. 1A, 1B and 1C depict some examples of the receiver coil according to embodiments of this invention;

FIG. 2 depicts the inter-dependence of currents and magnetic fields;

FIG. 3 depicts current distribution for discrete, equally spaced current turns;

FIG. 4 depicts current density distribution in the winding;

FIG. 5A, 5B depict resulting magnetic fields in different current and turn distribution;

FIG. 6 depicts magnetic field using a known fit function equation (1) with various fit parameters k_{W} (prior art);

FIG. 7 shows turn distribution of a coil according to embodiments of the invention;

FIG. 8 depicts resulting magnetic field for different algorithms;

FIG. 9A-9C: depicts comparison of resistance, inductivity and quality factor of a coil with distributed turns and equally spaced turns;

FIG. 10A-10C depicts change of resistance, inductivity and quality factor of a coil with distributed turns related to equally spaced turns as a function of the fit parameter;

FIG. 11 depicts turn distributions with minimum relative turn width wₘᵢₙ as parameter;

FIG. 12 depicts change of resistance, inductivity and quality factor of a coil with distributed turns according to the modified distribution function related to equally spaced turns as a function of the fit parameter;

FIG. 13 depicts magnetic field of distributed turns according to the modified distribution function;

FIG. 14I and FIG. 14II depict a simulation of coupling homogeneity with different receiver layouts;

FIG. 15 depicts a coupling factor of the litz wire coils for a radial displacement with vertical distance as parameter;

FIG. 16A shows an example of a system comprising a receiver coil designed according to an embodiment of the invention and three transmitter coils;

FIG. 16B shows an coupling inductance from each of the three transmitter coils to the receiver coil.

### DETAILED DESCRIPTION OF THE INVENTION

The invention solve the problem of receiving homogeneous power by creatively applying the law of reversibility of inductively coupled coils, i.e the transmitter and receiver coils may be exchanged in their function while maintaining the same coupling factor. To solve the problem of receiving a homogeneous flux from non-homogeneous magnetic field, this invention creatively applies a known design of a transmitter coil that is capable of generating a homogeneous magnetic field for designing a receiving coil so as to solve the problem of receiving homogeneous power on any position of transmitter coil.

As a result, a receiving device comprising a receiver coil constituted by winding turns is proposed, the winding turns are denser at the outer part of the coil than the winding turns at the inner part of the coil.

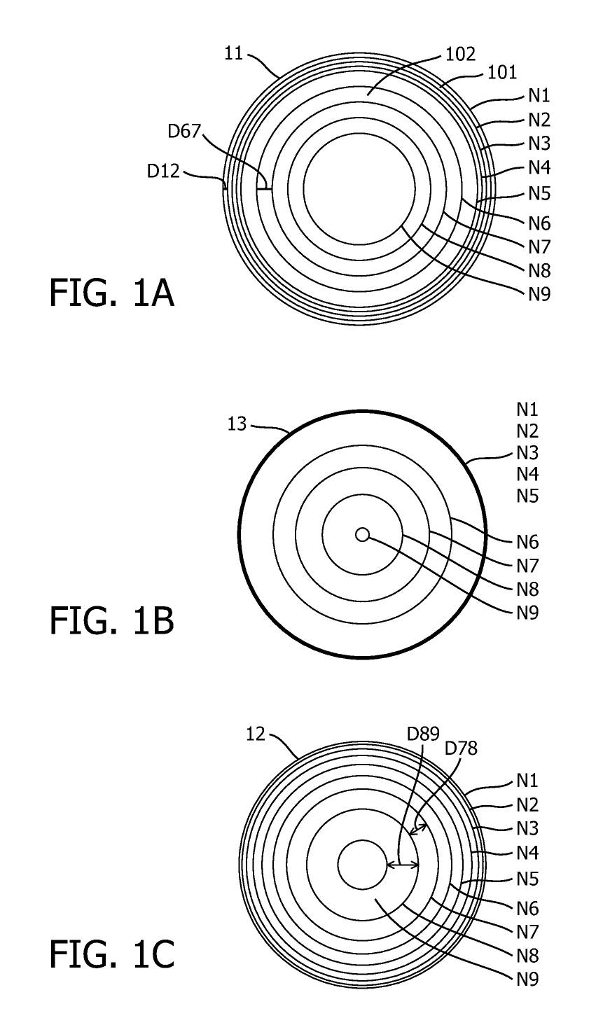

FIG. 1A to 1C depicts some examples of winding turns distribution. It is to be understood that although the winding turns are drawn as circles with centres at the same position for simplifying the drawings, the winding turns also may be and preferably be spiral-shaped turns.

The winding turns are denser at the outer part of the coil than the winding turns at the inner part of the coil means the distance of two neighbouring turns at the outer part is shorter than the distance of two neighbouring turns at the inner part. In the context of this invention, the distance of two neighbouring turns means the distance along the radial direction, for two circular turns, it equal to the difference of the radius of the two turns. To form a complete receiver coil, the turns maybe electronically connected (not shown in the figure) in series (for example a single spiral-shaped lize wire forms nine turns) or in parallel.

The outer part and the inner part may be a fixed two parts. The boundary of two parts could be determined according to the distances changing rule. For example, in FIG. 1A a receiver coil 11 constituted by nine winding turns which are referred to as N1, N2, . . . , N9. from outside to inside. The distance of two neighbouring turns along the radial direction is referred to as D12, . . . , D67, . . . , D89 (not all distances are shown in FIG. 1A). The Arabic numerals in the reference number denote the number of turns. For example, the distance between turns N1 and N2 is D12. From this example, the outside five turns N1˜N5 are distributed equally, as a result, the distances D12, D23, D34, and D45 are equal. The inside four turns N6˜N9 are also distributed equally, meaning the distances D67, D78, and D89 are also equal. But the distance D12, D23, D34, and D45 are smaller than the distances D67, D78, and D89. In this example, area formed by the five outside turns N1˜N5 is deemed as the outer part 101 of the receiver coil; area formed by the four inside turns is deemed as the inner part 102.

It does not matter whether the distance within the outer part or within the inner part is equal or not equal, as long as the distances of the neighbouring turns in the outer part is smaller than the distances of the neighbouring turns in the outer part, it meets the requirement of “the turns at the outer part is denser than the turns at the inner part”. The turns at the outer part and the turns at the inner part could have difference distance changing rule. For example, in FIG. 1B, the outside turns N1˜N5 are all concentrated at the outer circumference of the coil, the distances of the turns N1˜N5 are zero or almost zero, they are very close to each other. The distance of two neighbouring turns at inner part are increased gradually from outside to inside. Many other changing rules are possible. For example, the turns at outer part have equal distances and various at inner part or vice versa.

The outer part and the inner part may also be a relative concept. As another example in FIG. 1C, the distances of two neighbouring turns at the whole area of the coil are increased gradually from outside to inside, in other words, the winding turns are increasingly denser from the centre of the receiver coil to the outer edge of the receiver coil. For example, D89 is larger than D78. D78 is larger than D67, etc. In this case, there is not a definite boundary of inner part and outer part. Any turns could be referred to as at the outer part compare to the turns that are closer to the centre of the coil, at the same time, this turn could also be referred to as at the inner part compare to the turns that are further to the centre of the coil. For instance, the turn N5 may be regard as at inner part compare to the turns N1˜N4, it may also be regard as at the outer part compare to the turns N6˜N9.

The winding turns may be made of litz wire or if in a printed circuit board it may be made of conductive turns.

The invention also proposes the use of a planar receiver coil in a receiving device for receiving power from a transmitting device inductively, said receiver coil is intended to be coupled with a transmitter coil of said transmitting device, said receiver coil constituted by winding turns, wherein the winding turns at the outer part of the receiver coil are denser than the winding turns at the inner part of the receiver coil.

The invention also proposes an inductive power transmitting system that comprises a receiving device and a transmitting device. The receiving device comprises a planar receiver coil intended to be coupled with a transmitter coil of said transmitting device for receiving power from said transmitting device inductively, said receiver coil constituted by winding turns, wherein the winding turns at the outer part of the receiver coil are denser than the winding turns at the inner part of the receiver coil; and the transmitter coil is smaller than said receiver coil.

In the following, an algorithm for designing a receiving coil with winding turns denser at the outer part of the coil than the inner part of the coil is derived. According to the law of reversibility of inductively coupled coils, the applicant awares that if the transmitter coil could generate homogeneous power, when it is used as a receiver coil, it could receive homogeneous power no matter where the receiver coil is positioned along the radial direction of the transmitter coil. For easily illustrating the algorithm and measuring data, the algorithm is explained as if the receiver coil would be a transmitter coil.

### Solving the Inverse Field Problem

The task of finding a distribution of current turns which generate a desired magnetic field relates to the task of solving the inverse magnetic field problem. In principle, an infinite number of solutions are possible. However, with suitable restrictions it is possible to find one particular solution. As restrictions, the turns of the coil are placed in one layer and the coil is in circular or spiral shape with a limited outer radius.

In a first step, a current density distribution is calculated in the coil. This current density distribution should be able to generate a magnetic field, of which the vertical component is constant over the area of the coil at a certain height above the coil.

Then, in a second step, a turn distribution with a constant current in each turn is calculated, which narrows best the calculated current density distribution.

### Current Distribution

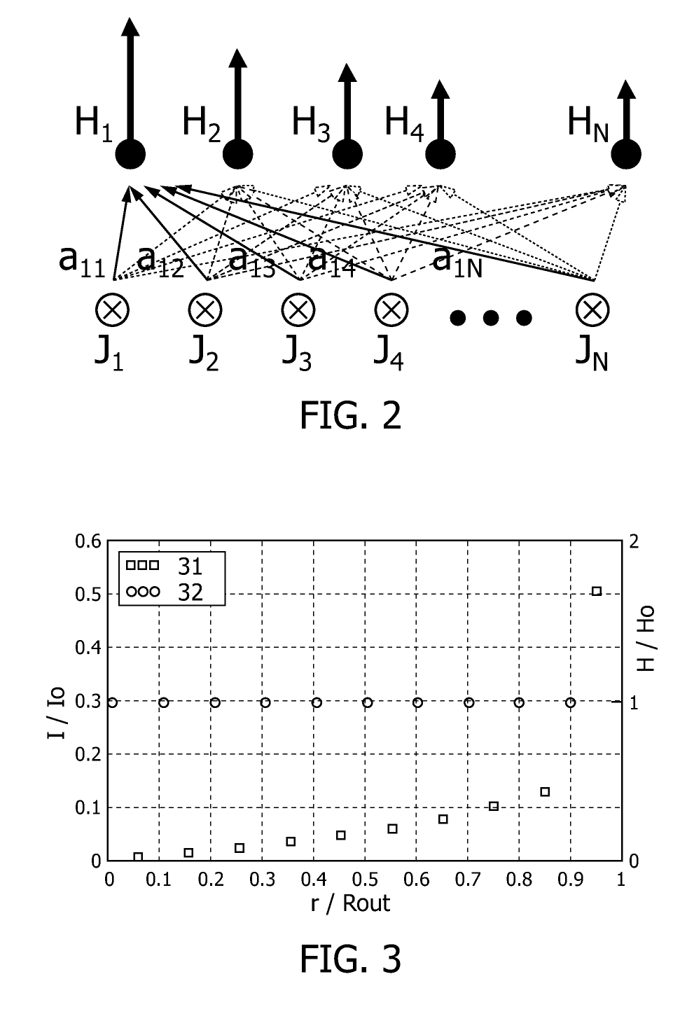

The suitable current distribution is calculated in a discrete approach. The winding width w of the coil is divided into a number Nturn of equally spaced current turns with an own, individually current value J(i) at the radial position r_{J}(i), where i is the index of the current turns. Above the coil, at a vertical distance z, a number of radial positions r_{H}(j) are defined, where the magnetic field H(j) will be specified. j denotes the index of the magnetic field positions. To be able to solve the problem uniquely, the number of magnetic field points is selected equal to the number of current turns. Each current turn contributes to the magnetic field at each magnetic field position, as illustrated in FIG. 2. In a good approximation, involved material properties can be assumed as linear. In this case, the dependence of the magnetic field on one of the current turns is linear. It can be expressed with a coefficient, as indicated in FIG. 2. The coefficient is dependent on the geometric properties and on involved materials. For some arrangements it can be calculated analytically.

To obtain one of the coefficients, the magnetic field at one position must be calculated from the current in one of the turns for one arbitrary current value:

a_{i,j}=H(rⱼ)/J(rᵢ) (2)

The coefficients of a circular coil in air without magnetic core or additional metal pieces can be calculated from loops (see section Magnetic field of a coreless loop in the following). For a circular plate core inductor, the magnetic field can be calculated according to the algorithm presented in “Design method and material technologies for passives in printed circuit board embedded circuits”, Special Issue on Integrated Power Electronics of the IEEE PELS Transactions, Vol. 20, No. 3, May 2005, p. 576, which is incorporated here for reference. For a general case, the coefficients can be calculated using Finite Element Method (FEM) simulations.

The current values can be combined to a vector \vec{J}, the values for the magnetic field can be combined to a vector \vec{H} and the coefficients can be combined to a matrix A. Then it is:

\vec{H}=A·\vec{J} (3)

If the values of the magnetic field are given and the current distribution is unknown, this equation can be inverted to:

\vec{J}=A⁻¹·\vec{H} (4)

Thus, the unknown current distribution can be calculated from the inverted coefficient matrix multiplied with the vector of required magnetic field values.

As an exemplary embodiment, a circular shaped coil in air without magnetic core is used here. To demonstrate the procedure, the winding width is divided into N_{I}=10 current turns.

FIG. 3 depicts current distribution for discrete, equally spaced current turns. In the horizontal axis, the position of the turns are represented by r/Rout which is the radial position r scaled to the outer radius Rₒᵤₜ of the coil, in the left vertical axis, the turn current is scaled to the total current in the winding which is denoted by and the right vertical axis denotes the magnetic field H/Ho. The resulting current distribution among the turns is shown as discrete dots 31. The figure also shows the positions, at which the magnetic field is specified as discrete dots 32. To avoid instabilities in the calculation, the magnetic field not specified until exactly the edge of the coil, but only to 90% of the outer radius.

### Turn Distribution

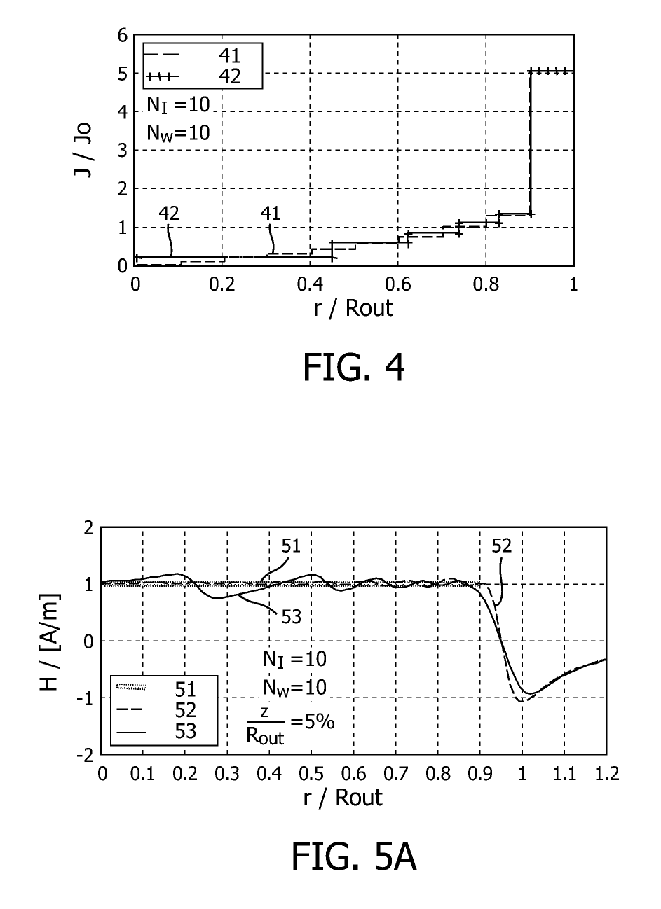

This optimal current distribution must be approximated by a distribution of the turns, where each turn comprises the same current. For this purpose, it is assumed in a first approximation that the turn width of each turn is as wide as possible and that the current is distributed homogeneously in the turn. FIG. 4 shows the desired result. The horizontal axis represents radial position r/Rout. The vertical axis represents current density J/Jo. The curve 41 shows the current density for equally spaced turns with different current per turn. The curve 42 corresponds to distributed turns, i.e. turns distributed unequally. If the current density is summed up over each width, the total current per turn is constant. It is clearly seen that both curves match as much as possible. The algorithm to achieve this distribution is described in detail in the following section: calculating the turn distribution from the current density distribution.

### Resulting Magnetic Field

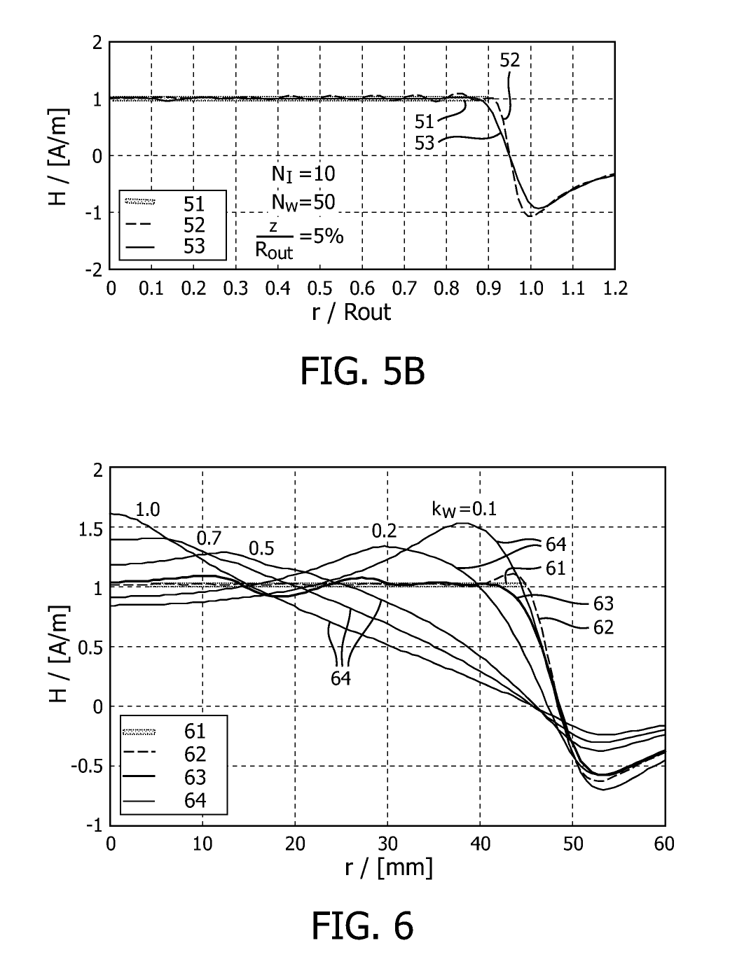

The resulting magnetic field is compared in FIGS. 5A and 5B. In both figures, the straight lines 51 are the specified magnetic field of exemplarily 1 A/m. The curves 52 show the resulting magnetic field for the case of “Variable Current Density” with N_{I}=10 current turns. A small ripple is visible at the outer part of the coil, caused by the limited discretisation. However, at the specified points (compare with FIG. 3) the curve matches exactly the specified value of 1 A/m. This proves the algorithm. The curves 53 correspond to the case of “Variable Turn Width”. The FIG. 5A is calculated for the case of N_{W}=10 turns of the structure (similar as in FIG. 4). Here, the ripple is higher as for the current distribution, because the turn density is rather low at the inside of the coil. However, this effect can be averaged out in the final application, because the opposite coil has a certain area. If the number of turns is increased to e.g. N_{W}=50 turns as shown in the FIG. 5B, the ripple nearly vanishes and the magnetic field is nearly perfectly constant over the width of the structure.

In the context of this invention, term “Variable Current Density” shall mean equally spaced turns with variable current in each turn which relates to a case of a conducting disk, where the current flow in that disk is position dependent, and only the numerical approach with finite current traces used to solve the problem gives the impression of an “equal turn distribution”

In the context of this invention, term “Variable Turn Width” relates to a turn distribution, which is calculated by first calculating an optimal current distribution by inverting the matrix and then obtaining the turn distribution from this. This is the method, which gives a better result, but which needs more effort.

And term “Approx. Turn Width” relates to a turn distribution obtained from one of the equations (e.g. eq.1, eq.5 or eq.7 in the description of the application), which directly results an approximate turn distribution. This method is much easier to handle, but the results may be less optimal, as shown in the following figures.

### Fit Function

To invert a matrix and solve the equation system needs some effort. Furthermore, the method is rather sensitive to geometric details and tends to give oscillating results. To ease the calculation of a turn distribution, a fit function is derived.

As already mentioned, Casanova et al. published an approach in “Transmitting Coil Achieving Uniform Magnetic Field Distribution for Planar Wireless Power Transfer System”, Proceedings of IEEE Radio and Wireless Symposium 2009, Jan. 18-22, 2009, p. 530, paper #TU4B-5, which is incorporated herein for reference. FIG. 6 shows the magnetic field using this fit function according to equation (1) by Casanova et al. with various fit parameters k_{W}.

The straight line 61 is the specified magnetic field of exemplarily 1 A/m.

Curve 62 shows the resulting magnetic field for the case of Variable Current Density.

Curve 63 shows the resulting magnetic field for the case of Variable Turn Width.

Curves 64 represent resulting magnetic field with turn distribution according to equation (1) with different fit parameters k_{W}. None of them matches well. Either, the field is too high at the edge or it decays fast. For all parameters it has a dedicated maximum.

Concluding, this function cannot reasonably match to a turn distribution calculated by solving the inverse magnetic field problem.

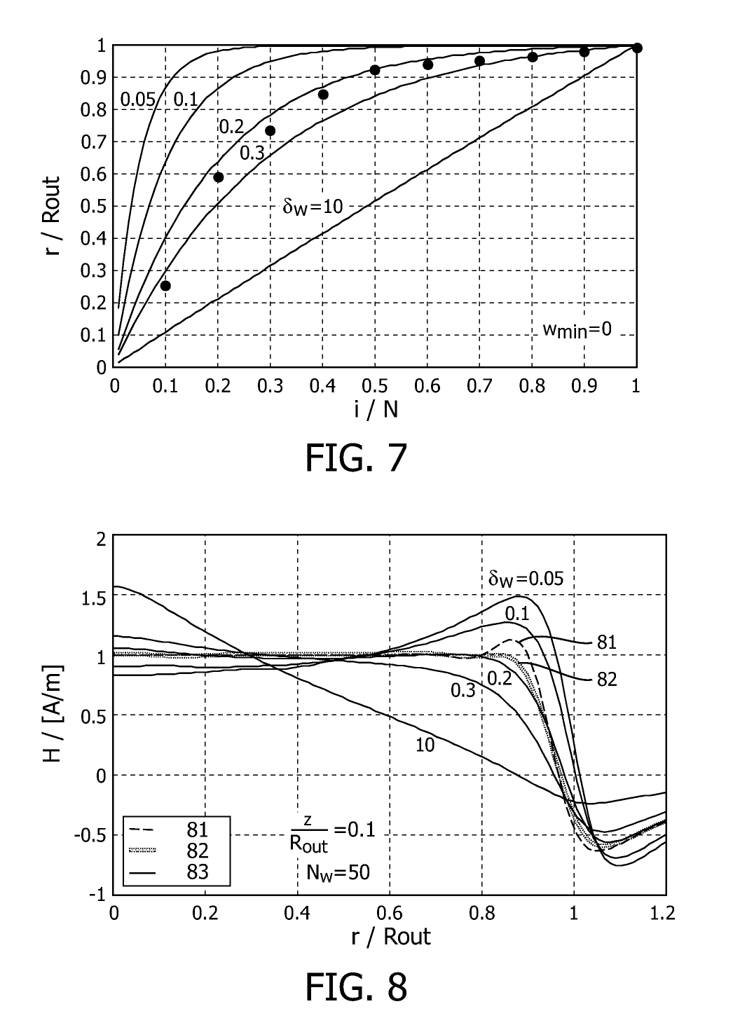

FIG. 7 shows the turn distribution. The horizontal axis represents turn number i/N. The vertical axis represents turn position r/Rout. The points are calculated by solving the inverse magnetic field problem. From the shape of this curve, a better equation is assumed:

$$\frac{r ( i )}{{R}_{out}} = \frac{1 - {e}^{\frac{\frac{- i}{N}}{{δ}_{w}}}}{1 - {e}^{\frac{- 1}{{δ}_{w}}}} \qquad ( 5 )$$

Wherein, r(i) is the turn position of the turn with index i. N is the number of turns. The parameter _{W} is a fit parameter which can be adjusted to fit the curve to an optimized turn distribution. FIG. 7 shows this function for different parameters _{W}. For a small _{W}, the turns are concentrated at the outer edge. For a very high value of _{W}, the distribution becomes linear. For negative _{W}, the turns are concentrated at the centre of the coil (not shown in the figure).

For a typical case as shown in FIG. 7, the fit parameter should be selected to approximately _{W}=0.2 to match the optimal turn distribution.

The resulting magnetic field for a coil with turn distribution according to equation 5 is depicted in FIG. 8.

Curve 81 depicts the magnetic field resulting from the current distribution (Variable Current Density),

Curve 82 depicts the magnetic field resulting from the distributed turns (Variable Turn Width).

The remaining curves all referred to as curve 83 depict the magnetic field for turn distributions according to the equation 5, the curves 83 are differentiate by fit parameters _{W} which lead to different turn distributions. The fit parameters in FIG. 8 are selected from the lowest value of _{W}=0.05 to the maximum value of _{W}=10 (linear distribution). As can be seen, one of a curve 83 which value of _{W} is 0.2 relates to the nearly optimal parameter resulting very homogeneous magnetic field distribution. Only close to the edge for r>0.8 Rₒᵤₜ, curve 82 gives slightly better results.

Concluding, the fit function according to equation (5) with a fit parameter of _{W}=0.2 gives sufficient good results for a homogeneous magnetic field.

### Modification of the Fit Function for Optimized Quality Factor

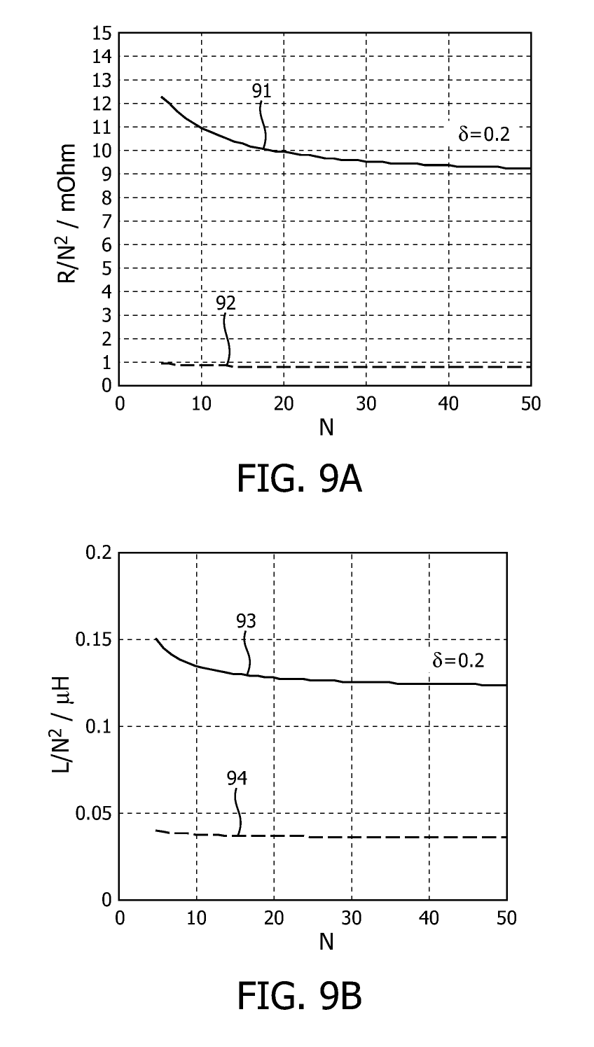

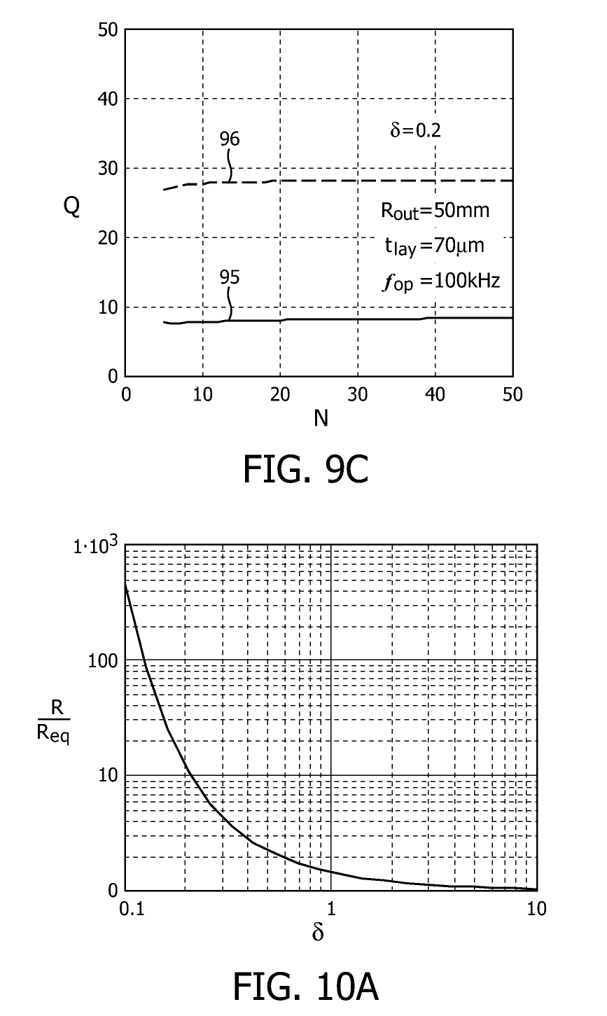

If the coil with distributed turns is realized in printed circuit board (PCB) technology, the width of the tracks (turns) is usually adapted such that a maximum amount of the copper layer is used. However, since the turns of an optimal distribution are concentrated at the outer edge, these tracks (turns) are significantly thinner than the average width. Therefore, the coil with optimized turn distribution has a significant higher resistance as a reference coil with an equal distribution of the turns with the same number of turns. However, the concentration of the turns at the outer edge also increases the inductance compared to the reference coil Important for an application is the ratio of the inductance L to its resistance R, expressed as the quality factor Q:

$$Q = \frac{2 \cdot π \cdot f \cdot L}{R} \qquad ( 6 )$$

Wherein, f is the operating frequency. To see, whether the increase of the resistance R or of the inductance L is more dominant, the resistance, the inductance and the quality factor Q are calculated for an exemplary structure for a varying number of turns N. The results are shown in FIG. 9A-C for the device with a turn distribution according to equation (5) with fit parameter =0.2 (curves 91, 93, and 95).

The horizontal axis of FIGS. 9A-C represent number of turns N.

The vertical axis of FIG. 9A represents resistance R/N (mOhm).

The vertical axis of FIG. 9B represents inductivity L/N (uH).

The vertical axis of FIG. 9C represents quality factor Q.

Further parameters are listed in FIGS. 9A-C. The curves 92, 94 and 96 shows the values for a reference device with equal turn distribution and equal dimensions. The resistance R and the inductivity L are scaled to the turn number per square N². Ideally, the results should be independent of N². For the equally spaced reference coil, this can be well assumed, as shown in the figures. For the coil with the distributed turns according to equation (5), a slight dependence of these scaled values is visible, but for higher N it approaches limit values. The value for a “high” turn number N=50 will be taken as value for further investigations. The figures further show that the resistance increases to about 10 times for the coil with distributed turns compared to the reference coil with equal turn distribution. The inductance increases only about 3 times for the coil with distributed turns compared to the reference coil with equal turn distribution. Therefore, the quality factor decreases by ⅓ compared to the reference coil with equal turn distribution.

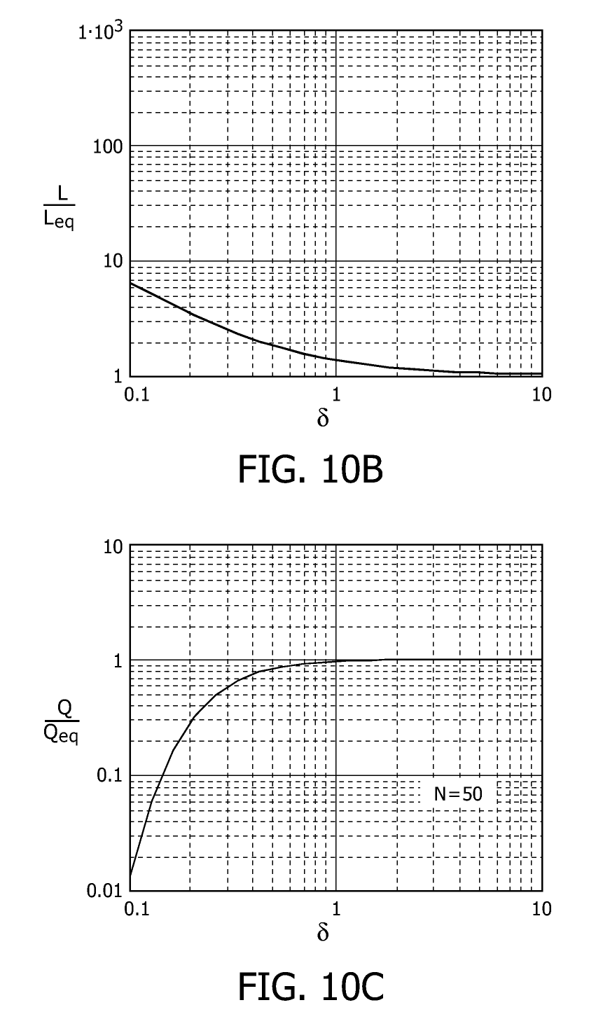

FIG. 10A-C shows this effect for different fit parameters , calculated with a “high” number of turns N=50. As expected, the resistance increase and thus the quality factor decrease is stronger for smaller values of , where the turns are even more concentrated at the outer edge and are thus even thinner. Contrary, for a fit parameter >0.5 the quality factor does no longer degrade significantly and is better than 90% of the reference coil. However, a design with those fit parameters lead to an inhomogeneous magnetic field distribution with higher values in the coil's centre (compare with FIG. 8).

‘To avoid the turns becoming too thin, a minimum turn width is introduced. To find a parameter, which is independent of the particular structure, the minimum turn width is related to the turn width of a reference structure with equal turn distributions and the same geometric dimensions.

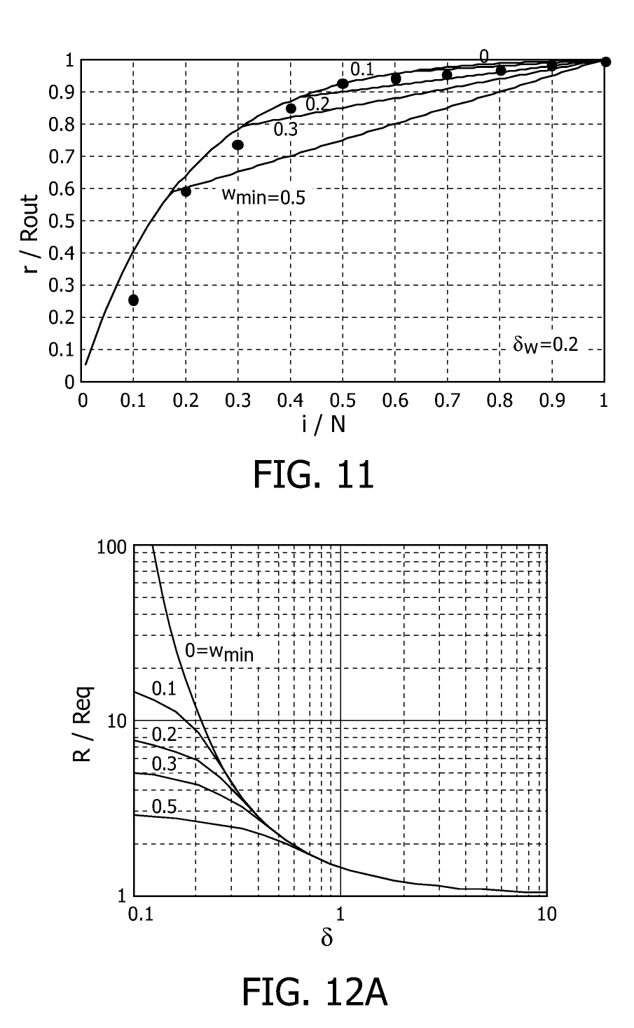

A modified algorithm for the turn distribution takes this minimum turn width parameter wₘᵢₙ into account and no turn must be smaller than this value. To achieve a turn distribution satisfying this criterion, the turns are first distributed from the outer edge to the inside as close as possible. Usually, these turn positions deviate from the optimal distribution. As soon as it is possible to place a turn on the optimal position without violating the width condition, the turn is placed there. Thus, at the inside of the coil the turns are on the same position as in the optimal distribution. FIG. 11 shows distributions according this procedure with different values of parameter wₘᵢₙ. From this figure, an analytic expression for this algorithm becomes obvious. At the outer edge, the distribution is linear and only dependent on the minimum turn width wₘᵢₙ. At the inner part, the distribution is still calculated according to equation (5). The final curve is the minimum of both values. Thus, the equation for the modified distribution results to:

$$\frac{r ( i )}{{R}_{out}} = min ( \frac{1 - {e}^{\frac{\frac{- i}{N}}{{δ}_{w}}}}{1 - {e}^{\frac{- 1}{{δ}_{w}}}} , 1 - {w}_{min} + \frac{i}{N} \cdot {w}_{min} ) \qquad ( 7 )$$

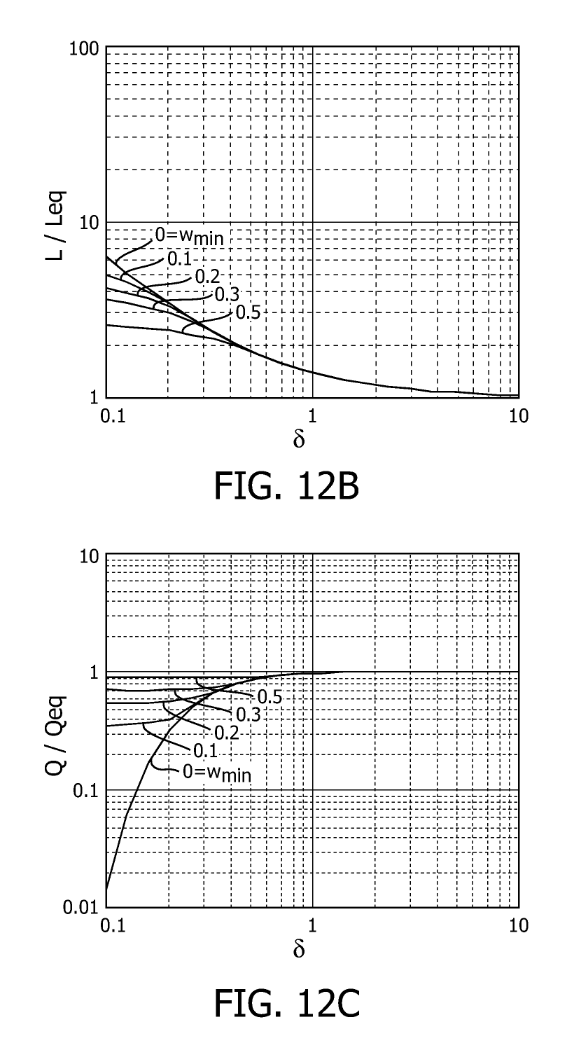

The effect of the introduction of a minimum turn width on resistance, inductance and quality factor is shown in FIG. 12A-C. Especially for small values of , where the turns are concentrated at the outer edge, a significant improvement with larger minimum turn widths can be seen.

The horizontal axis represents fit parameter delta .

The vertical axis of FIG. 12A represents resistance compared to the reference coil with equal turn distribution R/Req.

The vertical axis of FIG. 12B represents inductivity compared to the reference coil with equal turn distribution L/Leq.

The vertical axis of FIG. 12C represents the quality factor compared to the reference coil with equal turn distribution Q/Qeq.

Using a minimum turn width of wₘᵢₙ=0.2 at an optimal fit parameter of =0.2, the quality factor improves from 30% of the reference value to 70% of the reference value. A minimum width of wₘᵢₙ=0.5 even improves the quality factor to 90% of the reference value.

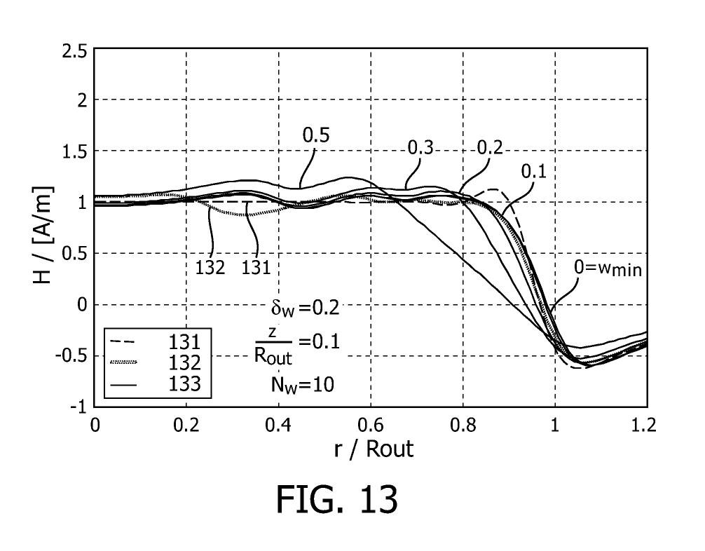

The effect on the magnetic field is shown in FIG. 13.

The horizontal axis represents radial position r/Rout.

The vertical axis represents magnetic field H.

As can be seen in the figure, the magnetic field in the centre part of the coil is hardly affected by modifying the turn distribution.

The curve 131 depicts the resulting magnetic field of a coil with Variable Current Density.

The curve 132 depicts the resulting magnetic field of a coil with Variable Turn Width.

The curves 133 depicts the resulting magnetic field of a coil with turn width distributed according to equation 7. The curves 133 differ in the minimum width of the tracks wₘᵢₙ. Increasing the minimum turn width leads to a less steep “edge” of the magnetic field at the outer edge of the coil. As can be seen, a minimum turn width of wₘᵢₙ=0.5 leads to a wide area of decay at the outer edge, which is not desired. However, at a minimum turn width of wₘᵢₙ=0.2 the magnetic field shows hardly a difference to the magnetic field of the optimal distribution.

Concluding, a minimum turn width of wₘᵢₙ=0.2 can improve the quality factor of a planar PCB coil from 30% compared to a reference coil with equal turn distribution to 70% of the reference coil and still gives good results for the homogeneity of the magnetic field.

### Exemplary Embodiment and Measurements

Based on these considerations a transmitter and a receiver coil are manufactured. The receiver coil has 8 turns and a diameter of 10 cm. Their positions are calculated using the modified distribution fit function (7). The resulting geometric dimensions are listed in Table 1. The transmitter coil is smaller. It has a diameter of 4.4 cm. If several transmitter coils are arranged in a hexagonal array, the receiver always covers one transmitter coil completely. Also the transmitter coil has non-equally spaced turns, which improves the coupling homogeneity further.

TABLE 1
Geometric properties of the litz wire coils

| | | | | | | | | | |
|---|---|---|---|---|---|---|---|---|---|
| Tx coil | | | | | | | | | |
| Design Name | | #1 | | | | | | | |
| Number of | N_tpl | 4 | | | | | | | |
| turns | | | | | | | | | |
| per layer | | | | | | | | | |
| Number of | N_lay | 2 | | | | | | | |
| serial layers | | | | | | | | | |
| Wire type | | 180 × | | | | | | | |
| | | 0.03 | | | | | | | |
| Outer coil | d_out | 44 | | | | | | | |
| diameter/mm | | | | | | | | | |
| Radial turn | r | 15.8 | 19.8 | 20.9 | 22 | | | | |
| positions/mm | | | | | | | | | |
| Rx coil | | | | | | | | | |
| Design Name | | #1 | | | | | | | |
| Number of | N_tpl | 8 | | | | | | | |
| turns | | | | | | | | | |
| per layer | | | | | | | | | |
| Number of | N_lay | 2 | | | | | | | |
| serial layers | | | | | | | | | |
| Wire type | | 180 × | | | | | | | |
| | | 0.03 | | | | | | | |
| Outer coil | d_out | 100 | | | | | | | |
| diameter/mm | | | | | | | | | |
| Radial turn | r | 23.4 | 35.9 | 42.6 | 45 | 46.25 | 147.5 | 48.75 | 50 |
| positions/mm | | | | | | | | | |

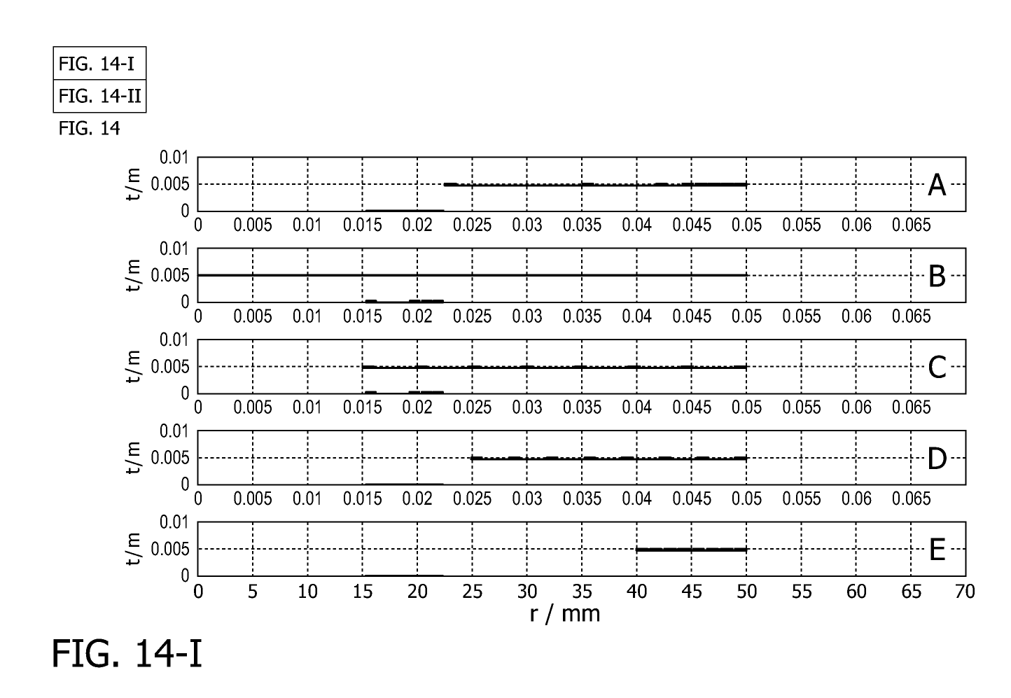

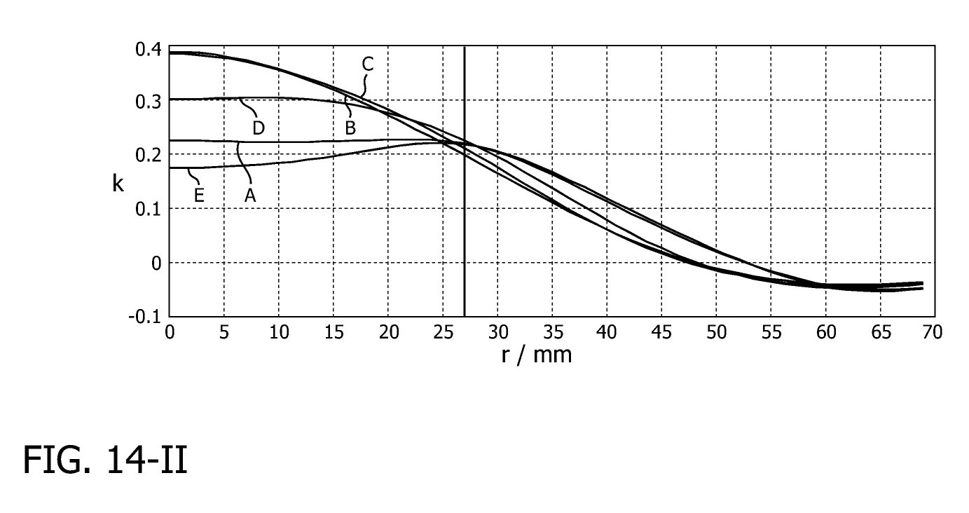

FIGS. 14I and II show coupling simulations of these two coils (curve B). FIG. 14II shows the coupling factor for a radial displacement of the two coils. In FIG. 14I, winding layouts are visualized. In addition, four different conventional receiver designs with constant turn distribution are compared. The vertical line at 27 mm marks the relevant range, where the two coils completely overlap. Clearly, the selected winding design has the most homogeneous coupling of all designs.

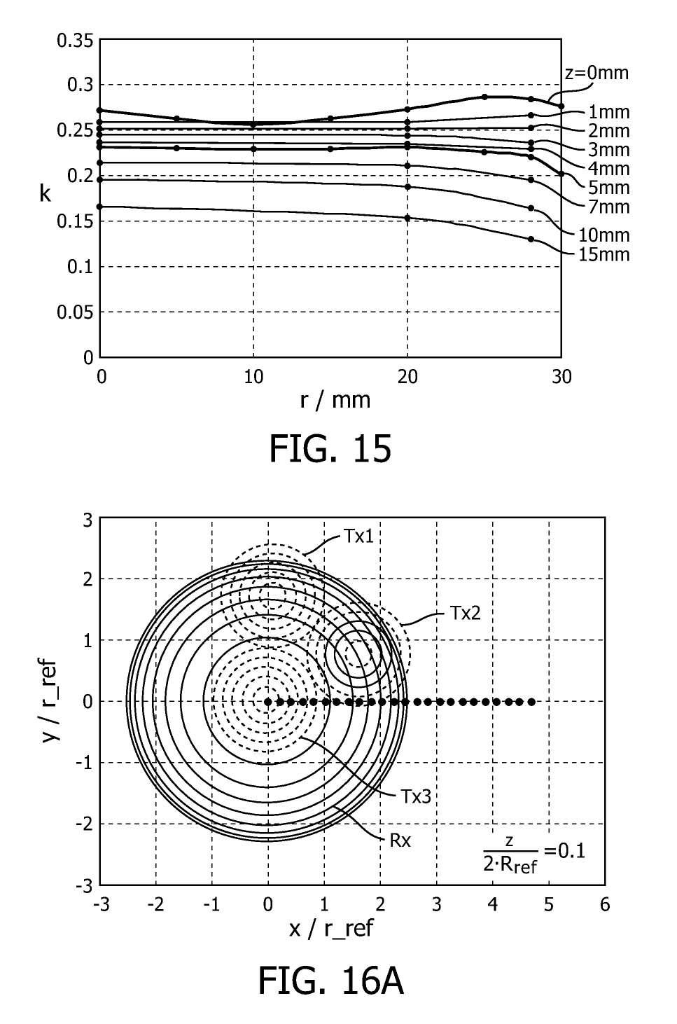

FIG. 15 shows related measurement results at different vertical distances z. The curve measured at a distance of 5 mm can be compared to the simulation in FIG. 14. Clearly, a good correspondence is visible. The coupling factor is very constant up to a displacement of 27 mm, which marks the relevant range of operation.

### Transmitter Array

To extend the range of operation, a number of transmitter cells can be arranged to an array.

It is preferred to arrange them in a way that always at least one transmitter coil is covered by the receiver coil. A regular hexagonal arrangement has the lowest number of transmitter coils per area to achieve this condition for a given size of the receiver. Therefore, it is preferred. For this arrangement, the size ratio of receiver coil to transmitter coil should be maximal 1:0.464.

To allow insulation space between the transmitter cells, this ratio is slightly reduced for the demonstrator. The receiver coil is specified to 10 cm diameter and the transmitter coil is designed to 4.4 cm diameter.

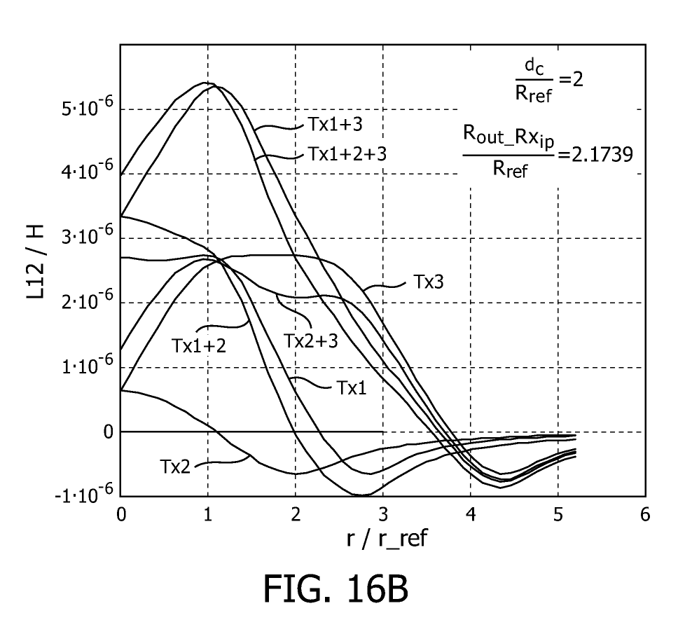

FIG. 16A shows an arrangement with three transmitter coils Tx1, Tx2, and Tx3 and a receiver coil Rx coupled with the transmitter coils. The receiver coil Rx is designed according to the equation 7, however, the transmitter coils comprises equally spaced turn distribution. According to above explanation, no matter how the transmitter coils Tx1, Tx2, Tx3 is designed (equal turn distribution or unequal turn distribution), the receiver coil can freely move within the area defined by the three transmitter coils, i.e. the receiver coil can be positioned arbitrarily as long as it covers any one of the three transmitter coils with a homogeneous power receiving.

FIG. 16B shows the coupling inductance (as a measure for the coupling factor) from each of the three transmitter coils to the receiver coil, if the receiver coil is moved along the path shown in the layout of FIG. 16A. It also shows the superposition, if two or three transmitter coils are active. If always only one transmitter coil, which in addition must be located completely under the receiver coil, is activated, this correspond to the blue curve switching to the green curve. Then, the figure shows that a very homogeneous coupling can be achieved over a larger area. By adding more coils, the related operating area can be arbitrarily extended.

### Application

The invention can be used in many different applications. For example, imagining a lamp with a receiver coil which needs power from a floor, wall or ceiling equipped with an array of Tx coils. It might not be possible to manufacture these large areas with Tx coils having an optimal turn distribution. Then the lamp can have a more sophisticated receiver with a special turn distribution as according to the invention and this allows a pretty homogeneous light output of the lamp on any arbitrary position without dedicated power control.

Other examples for applications are charging pads or areas, receivers in laptops, kitchen and bathroom appliances.

### Magnetic Field of a Coreless Loop

For a single circular loop centered on the z-axis, the axial magnetic field intensity H_{Z} is:

$${H}_{z} ( r , z , a , I ) := I \cdot \frac{1}{2 \cdot π \cdot \sqrt{{( a + r )}^{2} + {z}^{2}}} \cdot [ \frac{{a}^{2} - {r}^{2} - {z}^{2}}{{( a - r )}^{2} + {z}^{2}} \cdot E ( k ( a , r , z ) ) + K ( k ( a , r , z ) ) ] \qquad ( 8 )$$

### With

I=current in the loop

a=radius of the loop

r=radial position of the point

z=axial position of the point

K(k) is the Elliptic Integral of the first kind:

$$K ( k ) := {\int }_{0}^{\frac{π}{2}} \frac{1}{\sqrt{1 - {( k \cdot sin ( α ) )}^{2}}} d α \qquad ( 9 )$$

E(k) is the Elliptic Integral of the second kind

$$E ( k ) := {\int }_{0}^{\frac{π}{2}} \sqrt{1 - {( k \cdot sin ( α ) )}^{2}} d α \qquad ( 10 )$$

And the auxiliary function k is defined as

$$k ( a , r , z ) := 2 \cdot \sqrt{\frac{a \cdot r}{{( a + r )}^{2} + {z}^{2}}} \qquad ( 11 )$$

Calculating the Turn Distribution from the Current Density Distribution

To match the current distribution to a turn distribution, the following algorithm is used:

At first, the current per turn Iₜᵤᵣₙ is calculated from the sum of all currents I₀ in the equal turn distribution:

$${I}_{turn} = \frac{{\sum }_{i = 1}^{{N}_{i}} {j}_{i}}{{N}_{w}} \qquad ( 12 )$$

Where Nᵢ is the number of current turns and N_{W} the number of distributed turns. For further proceeding, refer to FIG. 4. To determine the width of the turn w, the current density times a small x is summed up as well as the x to a width. If the sum of all the small current equals the required current for one turn Iₜᵤᵣₙ, the necessary width of the turn w is reached. Then, the same current, summed up over the width w, flows in the turn of the distributed turn coil and in the turns (or parts of turns) of the equally spaced structure. As a further approximation, the resulting turns can be assumed as infinite thin with a position in the centre of the planar turn.

Summarizing the idea of the algorithm: Distribute the currents to the turns with variable width until one turn has the right amount of current.

The idea of this algorithm can be worked out, such that not small steps of x are taken, but sums are calculated up to the edges of the structure. This approach leads to the following algorithm, as implemented in MathCad:

$$\begin{matrix}{w}_{w} := \vert \begin{matrix}i ← 1 \\ {I}_{I \_ aux} ← {I}_{i} \\ {w}_{I \_ aux} ← {w}_{I} \\ for j ∈ 1 … {N}_{w} \\ \vert \begin{matrix}{I}_{w \_ aux} ← {I}_{w} \\ {w}_{w \_ aux} ← 0 \\ while {I}_{w \_ aux} > 0 \\ \vert \begin{matrix}\begin{matrix}\begin{matrix}if {I}_{w \_ aux} \leq {I}_{I \_ aux} \\ \vert \begin{matrix}\begin{matrix}\begin{matrix}\begin{matrix}\begin{matrix}d w ← {I}_{w \_ aux} \cdot \frac{{w}_{I \_ aux}}{{I}_{I \_ aux}} \\ {w}_{w \_ aux} ← {w}_{w \_ aux} + d w\end{matrix} \\ {w}_{I \_ aux} ← {w}_{I \_ aux} - d w\end{matrix} \\ d I ← {I}_{w \_ aux}\end{matrix} \\ {I}_{w \_ aux} ← {I}_{w \_ aux} - d I\end{matrix} \\ {I}_{I \_ aux} ← {I}_{I \_ aux} - d I\end{matrix}\end{matrix} \\ otherwise\end{matrix} \\ \vert \begin{matrix}d w ← {w}_{I\_aux} \\ {w}_{w\_aux} ← {w}_{w\_aux} + d w \\ {w}_{I\_aux} ← {w}_{I\_aux} - d w \\ d I ← {I}_{I\_aux} \\ {I}_{w\_aux} ← {I}_{w\_aux} - d I \\ {I}_{i\_aux} ← {I}_{I\_aux} - d I \\ if i < {N}_{I} \\ \vert \begin{matrix}\begin{matrix}i ← i + 1 \\ {I}_{I\_aux} ← {I}_{i}\end{matrix} \\ {w}_{I\_aux} ← {w}_{I}\end{matrix}\end{matrix}\end{matrix} \\ {w}_{j} ← {w}_{w\_aux}\end{matrix} \\ w\end{matrix} & ( 13 ) \\ \begin{matrix}Variables \text{:} & {I}_{w} = Current per turn \\ & i = Index for turns with variable current\end{matrix} \\ j = Index for turns with variable width \\ {I}_{w\_aux} = Auxiliary variable for the remaining current to \\ attributed \\ {w}_{w\_aux} = auxiliary variable for the actual width of the \\ calculated turn & \end{matrix}$$

Although the present invention has been described in connection with some embodiments, it is not intended to be limited to the specific form set forth herein. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A planar receiver coil for use in a receiving device for receiving power from a transmitting device inductively, the receiver coil being intended to be coupled with a transmitter coil of said transmitting device, said receiver coil constituted by winding turns, wherein the winding turns at the outer part of the receiver coil are denser than the winding turns at the inner part of the receiver coil.

2. A receiver coil as claimed in claim 1, wherein the winding turns at the outer part of the receiver coil are distributed equally.

3. A receiver coil as claimed in claim 1, wherein the winding turns at the outer part of the receiver coil are concentrated at the outer edge of the receiver coil.

4. A receiver coil as claimed in claim 1, wherein the winding turns at the inner part of the receiver coil are distributed equally.

5. A receiver coil as claimed in claim 1, wherein the winding turns are increasingly denser from the centre of the receiver coil to the outer edge of the receiver coil.

6. A receiver coil as claimed in claim 1, wherein the winding turns are distributed according to the algorithm of:
$$\frac{r ( i )}{{R}_{out}} = \frac{1 - {e}^{\frac{\frac{- i}{N}}{{δ}_{w}}}}{1 - {e}^{\frac{- 1}{{δ}_{w}}}}$$
Where, r(i) is the turn position of the turn with index I,
N is the number of turns,
δ_{W} is a fit parameter which can be adjusted to fit the curve to an optimized turn distribution,
Rₒᵤₜ is the outer radius of the coil.

7. A receiver coil as claimed in claim 1, wherein the winding turns are distributed according to the algorithm:
$$\frac{r ( i )}{{R}_{out}} = min ( \frac{1 - {e}^{\frac{\frac{- i}{N}}{{δ}_{w}}}}{1 - {e}^{\frac{- 1}{{δ}_{w}}}} , 1 - {w}_{min} + \frac{i}{N} \cdot {w}_{min} )$$
Where, r(i) is the turn position of the turn with index I,
N is the number of turns,
δ_{W} is a fit parameter which can be adjusted to fit the curve to an optimized turn distribution,
Rₒᵤₜ is the outer radius of the coil,
Wmin is minimum turn width.

8. A receiver coil as claimed in claim 1, wherein the winding turns are made of litz wire.

9. A receiver coil as claimed in claim 1, wherein the winding turns are made of conductive turns in a printed circuit board.

10. A receiving device for receiving power from a transmitting device inductively, comprising a planar receiver coil being intended to be coupled with a transmitter coil of said transmitting device, said receiver coil constituted by winding turns, wherein the winding turns at the outer part of the receiver coil are denser than the winding turns at the inner part of the receiver coil.

11. A system comprising a transmitting device and a receiving device, wherein:
said receiving device comprising a planar receiver coil being intended to be coupled with a transmitter coil of said transmitting device for receiving power from said transmitting device inductively, said receiver coil constituted by winding turns, wherein the winding turns at the outer part of the receiver coil are denser than the winding turns at the inner part of the receiver coil;
said transmitter coil is smaller than said receiver coil.

12. A system comprising a transmitting device and a receiving device, wherein:
said transmitting device having a transmitter coil array;
said receiving device comprising a planar receiver coil being intended to be coupled with at least one transmitter coil of said transmitting coil array for receiving power from said transmitting device inductively, said receiver coil constituted by winding turns, wherein the winding turns at the outer part of the receiver coil are denser than the winding turns at the inner part of the receiver coil; and
each of the transmitter coil in the array is smaller than said receiver coil

13. (canceled)
